(19) United States
(12) Patent Application Publication
(10) Pub. No.: US 2018/0126326 A1
(43) Pub. Date: May 10, 2018

(54) APPARATUS AND METHOD FOR CARBON DIOXIDE CAPTURE

(71) Applicant: SOGANG UNIVERSITY RESEARCH FOUNDATION, Seoul (KR)

(72) Inventors: Kwang-Soon LEE, Seoul (KR); Hui-Yong KIM, Seoul (KR); Jung-Hwan KIM, Gyeonggi-do (KR); Sung-June HWANG, Incheon (KR)

(21) Appl. No.: 15/701,706

(22) Filed: Sep. 12, 2017

(30) Foreign Application Priority Data
Nov. 7, 2016 (KR) 10-2016-0147610

(51) Int. Cl. B01D 53/14; B01D 53/18

(52) U.S. Cl. CPC B01D 53/1425; B01D 53/1475; B01D 2252/102; B01D 2252/20494; B01D 53/18

(57) ABSTRACT

According to one embodiment of the present invention, an apparatus for carbon dioxide capture includes an absorption tower in which an absorbent absorbs carbon dioxide contained in exhaust gas to thereby form a saturated absorbent; a stripping tower in which the carbon dioxide is stripped from the saturated absorbent transferred from the absorption tower and the absorbent is regenerated; a first heat exchanger configured to preheat the saturated absorbent while the saturated absorbent is being transferred from the absorption tower to the stripping tower; and a second heat exchanger configured to secondarily preheat the primarily preheated saturated absorbent.

### CROSS-REFERENCE TO RELATED PATENT APPLICATION

This application claims the benefit under 35 USC § 119(a) of Korean Patent Application No. 10-2015-0174274, filed on Dec. 8, 2015, in the Korean Intellectual Property Office, the entire disclosure of which is incorporated herein by reference for all purposes.

### FIELD

The following description relates to an apparatus and method for carbon dioxide capture, and more specifically, to an apparatus and method for carbon dioxide capture with excellent energy efficiency.

### BACKGROUND

Recently, efforts to capture and store greenhouse gases, which cause the global warming, have been made internationally. In particular, in order to reduce carbon dioxide of the greenhouse gases, many techniques, such as a chemical absorption method, an adsorption method, a membrane separation method, and a cryogenic air separation method, have been developed.

The chemical absorption method using an absorbent used to remove carbon dioxide generated in combustion facilities, such as thermoelectric power plants, has been studied extensively due to its high efficiency and stability. In this method, amine-based capture process for capturing carbon dioxide is a type of chemical absorption technology. In order to be effectively applied to a power plant, this process requires a high-efficiency, low-energy absorbent and improvement of absorption process to reduce energy used.

Particularly, in carbon dioxide absorption and stripping processes, a great deal of energy is consumed in regeneration of an absorbent, and development of a process related to the absorbent for reducing the energy consumed for regeneration is required.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an apparatus and method for carbon dioxide capture with excellent energy efficiency.

In one general aspect, there is provided an apparatus for carbon dioxide capture, including: an absorption tower in which an absorbent absorbs carbon dioxide contained in exhaust gas to thereby form a saturated absorbent; a stripping tower in which the carbon dioxide is stripped from the saturated absorbent transferred from the absorption tower and the absorbent is regenerated; a first heat exchanger configured to preheat the saturated absorbent while the saturated absorbent is being transferred from the absorption tower to the stripping tower; and a second heat exchanger configured to secondarily preheat the primarily preheated saturated absorbent.

The apparatus may further include a reboiler connected to the stripping tower and configured to supply the stripping tower with thermal energy required for regenerating the absorbent.

The apparatus may further include a first condenser and a reflux drum, both of which are configured to separate a mixture gas containing the carbon dioxide stripped in the stripping tower into condensate and the carbon dioxide.

The apparatus may further include a second condenser configured to cool the absorbent regenerated in the stripping tower before the absorbent is fed to the absorption tower.

The absorbent may include at least one of an amine-based absorbent, an amino acid salt, an inorganic salt solution, ammonia water, an ionic salt solution, and a hydrazine absorbent.

The apparatus may further include: a third heat exchanger connected to the absorption tower and configured to recover thermal energy from an unreacted gas of the exhaust gas which is not absorbed by the absorbent; and a generator configured to generate electricity using the thermal energy recovered in the third heat exchanger.

In another general aspect, there is provided a method of carbon dioxide capture, including: absorbing carbon dioxide contained in exhaust gas using an absorbent in an absorption tower to thereby form a saturated absorbent; forming a first saturated absorbent by primarily preheating the saturated absorbent using a first heat exchanger; forming a second saturated absorbent by secondarily preheating at least a part of the first saturated absorbent; injecting the first saturated absorbent and the second saturated absorbent into a stripping tower; and separating the carbon dioxide from the first saturated absorbent and the second saturated absorbent and regenerating the absorbent in the stripping tower.

The first saturated absorbent may be injected into an upper portion of the stripping tower and the second saturated absorbent may be injected into a middle portion of the stripping tower.

Other features and aspects will be apparent from the following detailed description, the drawings, and the claims.

### BRIEF DESCRIPTION OF THE DRAWINGS

FIG. 1 is a process diagram of an apparatus for carbon dioxide capture according to an embodiment of the present invention.

FIG. 2 is a process diagram of an apparatus for carbon dioxide capture according to another embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, exemplary embodiments will be described in detail with reference to the accompanying drawings so as to be easily practiced by a person of ordinary skill in the art. It should be understood that the present disclosure is not to be construed as limited to the exemplary embodiments set forth herein and may be embodied in many different forms.

Any redundant descriptions of well-known parts will be omitted for clarity, and like reference numerals refer to like elements throughout the specification.

Sizes and thicknesses of elements in the drawings may be exaggerated for convenience of explanation. In other words, since sizes and thicknesses of components in the drawings are arbitrarily illustrated for convenience of explanation, the following embodiments are not limited thereto. In the drawings, thicknesses are enlarged for clarity of various layers and regions. In addition, thicknesses of some layers and regions are exaggerated for convenience of description.

In the specification, unless explicitly described to the contrary, the word “comprise” and variations such as “comprises” or “comprising,” will be understood to imply the inclusion of stated elements but not the exclusion of any other elements.

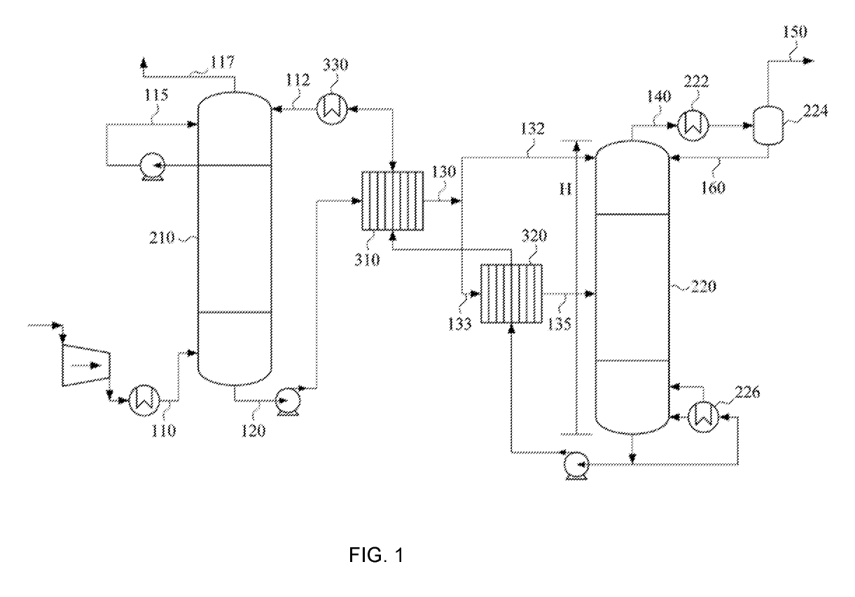

Hereinafter, an apparatus and method for carbon dioxide capture according to embodiments of the present invention will be described in detail with reference to FIG. 1.

FIG. 1 is a process diagram of an apparatus for carbon dioxide capture according to an embodiment of the present invention.

Referring to FIG. 1, the apparatus for carbon dioxide capture according to the embodiment of the present invention includes an absorption tower 210, a stripping tower 220, a first heat exchanger 310, a second heat exchanger 320, a first condenser 222, a second condenser 330, a reflux drum 224, and a reboiler 226.

First, exhaust gas 110 and an absorbent 112 are supplied to the absorption tower 210. In this case, the exhaust gas 110 may be combustion exhaust gas containing carbon dioxide. The absorbent 112 may include, for example, an amine-based absorbent, an amino acid salt, an inorganic salt solution, ammonia water, an ionic salt solution, and a hydrazine absorbent, and the absorbent 112 may be supplied in the form of an aqueous solution mixed with water.

At this time, droplets of the absorbent 112 or the steam may be prevented by using circulating washing water 115 or makeup water (not shown) so as to maintain the water balance in the process.

In the absorption tower 210, the absorbent 112 and the exhaust gas 110 are in countercurrent contact. The absorbent 112 absorbs carbon dioxide contained in the exhaust gas 110 and generates a saturated absorbent 120, which is discharged to a lower portion of the absorption tower 210. Unreacted gas 117 in the exhaust gas 110 which does not react with the absorbent 112 is discharged to an upper portion of the absorption tower 210. The absorption tower 210 may be operated in various temperature ranges according to the type of absorbent 112.

The saturated absorbent 120 is pumped to the first heat exchanger 310, and may become a first saturated absorbent 130 which is primarily preheated by the first heat exchanger 310.

A part 132 of the first saturated absorbent 130, which is primarily preheated by the first heat exchanger 310, may be directly injected into the stripping tower 220, and the remaining absorbent 133 may be transferred to the second heat exchanger 320 and be injected into the stripping tower 220 in the form of a second saturated absorbent 135, which is secondarily preheated by the second heat exchanger 320.

The apparatus for carbon dioxide capture according to the embodiment of the present invention uses the two heat exchangers 310 and 320 to further preheat the saturated absorbent 120, which is transferred from the absorption tower 210 to the stripping tower 220, thereby optimizing a temperature condition of the saturated absorbent 120 to be injected to the stripping tower 220, and consequently, achieving a better energy efficiency than a conventional carbon dioxide capturing apparatus having a single heat exchanger.

In this case, the primarily preheated first saturated absorbent 130 may be injected into an upper portion of the stripping tower 220 and the primarily and secondarily preheated second saturated absorbent 135 may be injected into a middle portion of the stripping tower 220. Here, the upper portion refers to the uppermost ⅓ portion of the total height H of the stripping tower 220, and the middle portion refers to the portion interposed between the lowermost ⅓ portion of the total height H of the stripping tower 220 and the uppermost ⅓ portion of the total height H.

As the first saturated absorbent 130 and the second saturated absorbent 135 injected into the stripping tower 220 moves downward in the stripping tower 220, the carbon dioxide contained in the saturated absorbent 120 may be stripped by means of thermal energy supplied from the reboiler 226 and the absorbent 112 may be regenerated.

At this time, a heat source, such as turbine steam, may be supplied to the reboiler 226 in order to maintain the regeneration condition of the absorbent 112 in the stripping tower 220.

A mixture gas 140 of carbon dioxide and exhaust steam is separated into condensate 160 and carbon dioxide 150 while passing through the first condenser 222 and the reflux drum 224. The carbon dioxide 150 may be transferred to the recovery process or the treatment process and stored, and the condensate 160 is resupplied to the stripping tower 220.

The absorbent 112 regenerated in the stripping tower 220 may be pumped to pass through the second heat exchanger 320, the first heat exchanger 310, and the second condenser 330, thereby be cooled down to the temperature of the absorption tower 210, and then may be supplied to the upper portion of the absorption tower 210.

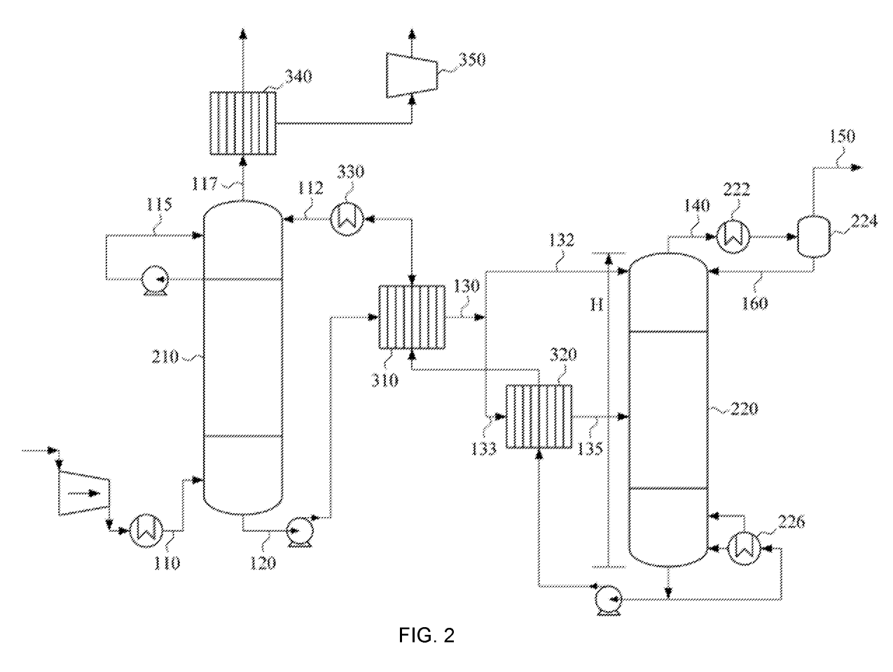

Hereinafter, an apparatus and method for carbon dioxide capture according to another embodiment of the present invention will be described in detail with reference to FIG. 2.

FIG. 2 is a process diagram of an apparatus for carbon dioxide capture according to another embodiment of the present invention.

Referring to FIG. 2, the apparatus for carbon dioxide capture according to another embodiment of the present invention includes an absorption tower 210, a stripping tower 220, a first heat exchanger 310, a second heat exchanger 320, a third heat exchanger 340, a first condenser 222, a second condenser 330, a reflux drum 224, a reboiler 226, and a generator 350.

First, exhaust gas 110 and an absorbent 112 are supplied to the absorption tower 210. Here, the exhaust gas 110 may be combustion exhaust gas containing carbon dioxide. The absorbent 112 may include, for example, an amine-based absorbent, an amino acid salt, an inorganic salt solution, ammonia water, an ionic salt solution, and a hydrazine absorbent, and the absorbent 112 may be supplied in the form of an aqueous solution mixed with water.

At this time, droplets of the absorbent 112 or the steam may be prevented by using circulating washing water 115 or makeup water (not shown) so as to maintain the water balance in the process.

In the absorption tower 210, the absorbent 112 and the exhaust gas 110 are in countercurrent contact. The absorbent 112 absorbs carbon dioxide contained in the exhaust gas 110 and generates a saturated absorbent 120, which is discharged to a lower portion of the absorption tower 210. Unreacted gas 117 in the exhaust gas 110 which does not react with the absorbent 112 is discharged to an upper portion of the absorption tower 210. The absorption tower 210 may be operated in various temperature ranges according to the type of absorbent 112.

The apparatus for carbon dioxide capture according another embodiment of the present invention further includes the third heat exchanger 340 to recover thermal energy present in the unreacted gas 117 discharged through the upper portion of the absorption tower 210. The thermal energy present in the unreacted gas 117 is recovered through the third heat exchanger 340 and extra energy, such as electricity, may be generated using the recovered thermal energy and the generator 350.

The process of generating the extra energy through the thermal energy may be performed using various known techniques.

The saturated absorbent 120 is pumped to the first heat exchanger 310, and may become a first saturated absorbent 130 which is primarily preheated by the first heat exchanger 310.

A part 132 of the first saturated absorbent 130, which is primarily preheated by the first heat exchanger 310, may be directly injected into the stripping tower 220, and the remaining absorbent 133 may be transferred to the second heat exchanger 320 and be injected into the stripping tower 220 in the form of a second saturated absorbent 135, which is secondarily preheated by the second heat exchanger 320.

The apparatus for carbon dioxide capture according to the embodiment of the present invention uses the two heat exchangers 310 and 320 to further preheat the saturated absorbent 120, which is transferred from the absorption tower 210 to the stripping tower 220, thereby optimizing a temperature condition of the saturated absorbent 120 to be injected to the stripping tower 220. In addition, the apparatus recovers the thermal energy present in the unreacted gas 117, which is discharged to the upper portion of the absorption tower 210, through the third heat exchanger 340 the generator 350 to generate extra energy, thereby increasing the energy efficiency of the entire carbon dioxide capture process.

In this case, the primarily preheated first saturated absorbent 130 may be injected into an upper portion of the stripping tower 220 and the primarily and secondarily preheated second saturated absorbent 135 may be injected into a middle portion of the stripping tower 220.

As the first saturated absorbent 130 and the second saturated absorbent 135 injected into the stripping tower 220 moves downward in the stripping tower 220, the carbon dioxide contained in the saturated absorbent 120 may be stripped by means of thermal energy supplied from the reboiler 226 and the absorbent 112 may be regenerated.

At this time, a heat source, such as turbine steam, may be supplied to the reboiler 226 in order to maintain the regeneration condition of the absorbent 112 in the stripping tower 220.

A mixture gas 140 of carbon dioxide and exhaust steam is separated into condensate 160 and carbon dioxide 150 while passing through the first condenser 222 and the reflux drum 224. The carbon dioxide 150 may be transferred to the recovery process or the treatment process and stored, and the condensate 160 is resupplied to the stripping tower 220.

The absorbent 112 regenerated in the stripping tower 220 may be pumped to pass through the second heat exchanger 320, the first heat exchanger 310, and the second condenser 330, thereby be cooled down to the temperature of the absorption tower 210, and then may be supplied to the upper portion of the absorption tower 210.

According to the embodiments of the present invention, the apparatus and method for carbon dioxide capture may increase the energy efficiency of the entire carbon dioxide capture process by disposing and using a plurality of heat exchanger between the absorption tower and the stripping tower.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for carbon dioxide capture, comprising:
an absorption tower in which an absorbent absorbs carbon dioxide contained in exhaust gas to thereby form a saturated absorbent;
a stripping tower in which the carbon dioxide is stripped from the saturated absorbent transferred from the absorption tower and the absorbent is regenerated;
a first heat exchanger configured to preheat the saturated absorbent while the saturated absorbent is being transferred from the absorption tower to the stripping tower; and
a second heat exchanger configured to secondarily preheat the primarily preheated saturated absorbent.

2. The apparatus of claim 1, further comprising a reboiler connected to the stripping tower and configured to supply the stripping tower with thermal energy required for regenerating the absorbent.

3. The apparatus of claim 2, further comprising a first condenser and a reflux drum, both of which are configured to separate a mixture gas containing the carbon dioxide stripped in the stripping tower into condensate and the carbon dioxide.

4. The apparatus of claim 3, further comprising a second condenser configured to cool the absorbent regenerated in the stripping tower before the absorbent is fed to the absorption tower.

5. The apparatus of claim 1, wherein the absorbent includes at least one of an amine-based absorbent, an amino acid salt, an inorganic salt solution, ammonia water, an ionic salt solution, and a hydrazine absorbent.

6. The apparatus of claim 1, further comprising:
a third heat exchanger connected to the absorption tower and configured to recover thermal energy from an unreacted gas of the exhaust gas which is not absorbed by the absorbent; and
a generator configured to generate electricity using the thermal energy recovered in the third heat exchanger.

7. A method of carbon dioxide capture, comprising:
absorbing carbon dioxide contained in exhaust gas using an absorbent in an absorption tower to thereby form a saturated absorbent;
forming a first saturated absorbent by primarily preheating the saturated absorbent using a first heat exchanger;
forming a second saturated absorbent by secondarily preheating at least a part of the first saturated absorbent;
injecting the first saturated absorbent and the second saturated absorbent into a stripping tower; and
separating the carbon dioxide from the first saturated absorbent and the second saturated absorbent and regenerating the absorbent in the stripping tower.

8. The method of claim 7, wherein the first saturated absorbent is injected into an upper portion of the stripping tower and the second saturated absorbent is injected into a middle portion of the stripping tower.

9. The method of claim 7, wherein thermal energy required for regenerating the absorbent is supplied to the stripping tower using a reboiler connected to the stripping tower.

10. The method of claim 7, further comprising:
recovering thermal energy from an unreacted gas of the exhaust gas which is not absorbed by the absorbent through a third heat exchanger connected to the absorption tower.
